(19) United States
(12) Patent Application Publication
(10) Pub. No.: US 2025/0171921 A1
(43) Pub. Date: May 29, 2025

(54) SYSTEM AND METHOD FOR PRODUCING HYDROGEN

(71) Applicant: Hydrogen Lift Sweden AB, GÄVLE (SE)

(72) Inventors: Haim BEAR, JÄTTENDAL (SE); Mats NILSSON, HUDIKSVALL (SE)

(73) Assignee: Hydrogen Lift Sweden AB, GÄVLE (SE)

(21) Appl. No.: 18/841,014

(22) PCT Filed: Feb. 27, 2023
(86) PCT No.: PCT/EP2023/054782

§ 371 Date: Aug. 23, 2024

(30) Foreign Application Priority Data
Feb. 28, 2022 (SE) 2250272-8

(51) Int. Cl. C25B 15/023; C25B 1/04; C25B 9/67; C25B 15/021

(52) U.S. Cl. CPC C25B 15/023; C25B 1/04; C25B 9/67; C25B 15/021

(57) ABSTRACT

The present invention relates to a system and method for producing hydrogen gas. The system comprises at least one gas transport vessel which is arranged to transport at least hydrogen up through water by buoyancy, a heat transfer unit connected to an electrolysis unit and arranged to transfer at least a portion of the waste heat from the electrolysis unit to the hydrogen gas that is to be transported by the gas transport vessel.

### FIELD OF THE INVENTION

The present invention relates to a system and method for producing hydrogen and optionally oxygen. In particular the invention relates to a system and method for producing hydrogen utilizing an electrolyzing apparatus and utilizing excess heat from the electrolyzing apparatus to heat at least one of the produced gases.

### BACKGROUND OF THE INVENTION

Hydrogen gas is fundamental in many industrial processes, for example steel production and production of fertilizers and has in recent years emerged as the energy carrying substance in electricity production based on fuel cells. As such hydrogen gas has the potential of becoming the main transportation fuel, due to an unmatched energy content.

Fuel cell based technology and for example steel production utilizing hydrogen gas can be much better from environmental and sustainability perspectives than the techniques utilized today. In particular, techniques and systems relaying on fossil fuels, but also battery-based technologies. However, in order for hydrogen-based technologies to become attractive from the environment and sustainability perspective hydrogen must be produced by other methods than the today dominating production using fossil fuels, primarily natural gas.

Electrolysis of water is an alternative method of producing hydrogen gas. The electrolysis itself is very clean with only oxygen gas as the biproduct, which also has a high commercial value. But the consumption of energy in form of electricity has so far made hydrogen production based on electrolysis less attractive from a cost perspective as compared to the methods using fossil fuels. Another drawback with electrolysis of water is that typically the electrolysis process and the equipment has been sensitive to impurities in the water. Sea water, for example, has not previously been possible to use without extensive desalination and purification. However, recently methods and equipment have become available that makes it possible to use sea water directly for the electrolysis process as disclosed in Solar-driven, highly sustained splitting of seawater into hydrogen and oxygen fuels, Yun Kuang et al, PNAS Apr. 2, 2019 116 (14) 6624-6629; first published Mar. 18, 2019.

Also, the efficiency of the electrolysis process has improved substantially in recent years, with reported electrical efficiency, for lab-scale prototypes up to 80%. However, commercially available units typically have efficiencies well below 60%. Hence, significant improvements are needed to get the cost of hydrogen production by electrolysis on par with the production based on fossil fuels.

The water electrolysis process is known for producing large amounts of heat which needs to be lead away through a cooling system. Typically, the produced heat can be considered as waste heat with regards to the electrolysis production, but may similarly to other industrial processes producing heat be used for lower grade application such as heating houses or facilities.

U.S. Ser. No. 16/953,195 discloses a method and a system wherein waste heat from the water electrolysis process is recovered and provided to a electrochemical hydrogen pump which requires heat to initiate the electrochemical hydrogen compression. Thereby the overall efficiency of the system is increased.

WO2014153249 discloses placing the production of hydrogen in an underwater plant. The primary purpose is to reduce the risk of the produced hydrogen, or oxyhydrogen, to be ignited and cause an explosion.

U.S. Ser. No. 11/007,690 discloses a method and a system for generating power through the capture of gas bubbles. One gas source is described to be an apparatus utilizing hydrolysis to produce hydrogen and oxygen from water and letting the produced gases bubble through water in form of a gas mixture.

### SUMMARY OF THE INVENTION

The object of the invention is to provide a system and method for producing hydrogen and optionally oxygen in a way that is acceptable from environmentally and sustainability aspects and at a cost comparable with fossil fuel-based techniques.

This is achieved by the system as defined in claim 1, and the method as defined in claim 14.

According to a first aspect of the invention, a system for producing hydrogen gas is provided.

The system is configured to be arranged in or in connection with a water volume forming a waterfilled gas rise column provided with a lower end and an upper end. The system comprises:
an electrically driven electrolysis unit provided in proximity to the lower end of the waterfilled gas rise column and provided with a water inlet and at least one gas outlet, the electrolysis unit being arranged to during use split water into hydrogen gas and oxygen gas in an electrolysis process in which process waste heat is produced;
at least one gas transport vessel provided with at least one cavity, a gas inlet and a gas outlet leading to the cavity, and arranged to receive a predetermined volume of hydrogen gas in the cavity and to transport the hydrogen gas from the bottom to the top of the gas rise column by buoyancy provided by the transported gas;
gas connecting means provided at the lower end of the waterfilled gas rise column and arranged to provide a detachable gas transport connection between the electrolysis unit and the gas inlet of the gas transport vessel, and gas delivering means provided at the upper end of the waterfilled gas rise column and arranged to provide a detachable gas transport connection between the gas outlet and a gas collector; and
a heat transfer unit connected to the electrolysis unit and to the gas connecting means or the gas transport vessel and arranged to transfer at least a portion of the waste heat from the electrolysis unit to hydrogen gas in the gas connecting means or to hydrogen gas in the gas transport vessel.

According to one embodiment of the invention the heat transfer unit comprises a first heat circuitry arranged in contact with heat generating parts of the electrolysis unit and thereby cools the electrolysis unit, a second heat circuitry arranged to heat the gas produced by the electrolysis unit, and a heat exchanger arranged to transfer heat from the first heat circuitry to the second heat circuitry.

According to one embodiment of the invention the heat transfer unit comprises a flow through gas heater provided between the electrolysis unit and the gas connecting means.

According to one embodiment of the invention the heat transfer unit comprises an internal heating arrangement provided in the gas transport vessel and forming a part of the second heat circuitry.

According to one embodiment of the invention the internal heating arrangement comprises a coil arranged in the interior of the gas transport vessels. According to one embodiment the internal heating arrangement comprises a heating jacket arranged in at least part of the wall of the gas transport vessel.

According to one embodiment of the invention the gas transport vessel comprises a pressure regulating arrangement arranged to control the gas pressure within the cavity of the gas transport vessel in relation to the external pressure and thereby controlling the buoyancy of the gas transport vessel during the gas transport vessel filled with heated gas received from the electrolysis unit rising upward in the gas rise column.

According to one embodiment of the invention the pressure regulating arrangement comprises:
a control valve arranged to provide fluid communication between the cavity and the exterior of the gas transport vessel or to a gas container separate from the cavity;
an internal pressure sensor arranged to provide a measure of the pressure of the gas contained in the cavity; and
an external pressure sensor arranged to provide a measure of the pressure of the water surrounding the gas transport vessel, wherein
   the internal pressure sensor and the external pressure sensor are arranged to affect the regulation of the control valve to control the pressure inside the cavity in relation to the pressure outside of the gas transport vessel so that a predetermined buoyancy is achieved.

According to one embodiment of the invention the pressure regulating arrangement further comprises a control unit arranged to receive measurement data from the internal pressure sensor and the external pressure sensor and arranged to control the control valve and wherein the control unit has a stored pressure profile and arranged to regulate the control valve according to the stored pressure profile.

According to one embodiment of the invention the gas transport vessel comprises:
an incompressible container provided with an main cavity;
an expansion vessel arranged to be able change volume and affected by both internal and external pressure, and
a tubing connecting the incompressible container and the expansion vessel, the tubing provided with a control valve;
an internal pressure sensor arranged to provide a measure of the pressure of the gas contained in the main cavity and an external pressure sensor arranged to provide a measure of the pressure of the water surrounding the gas transport vessel, and wherein
   the internal pressure sensor and the external pressure sensor are arranged to affect the regulation of the control valve and thereby control the flow of gas between the main cavity and the expansion vessel.

According to one embodiment of the invention:
the incompressible container is double walled providing an insulating space between an inner and an outer wall of the incompressible container; and
the incompressible container is provided with a differential pressure sensor arranged to provide a measure of the difference in the gas pressure in the main cavity and the insulating space and a second volume and pressure regulating valve arranged to equalize the pressure between the main cavity and the insulating space.

According to one embodiment of the invention the system for producing hydrogen gas comprises a belt to which a plurality of gas transport vessels is attached, the belt being arranged to drive an electrical generator.

According to a second aspect of the invention, a combined system for producing hydrogen gas and oxygen gas is provided. The combined system is configured to be arranged in or in connection with at least one water volume forming a first waterfilled gas rise column provided with a lower end and an upper end, and a second waterfilled gas rise column provided with a lower end and an upper end, the combined system comprising:
an electrically driven electrolysis unit configured to be provided in proximity to the lower ends of the first and second waterfilled gas rise columns and provided with a water inlet, a hydrogen gas outlet and an oxygen gas outlet, the electrolysis unit being arranged to during use split water into hydrogen gas and oxygen gas in an electrolysis process in which process waste heat is produced,
a hydrogen subsystem comprising:
   at least one hydrogen gas transport vessel provided with at least one cavity, a gas inlet and a gas outlet leading to the cavity, and arranged to receive a predetermined volume of hydrogen gas in the cavity and to transport the hydrogen gas from the bottom to the top of the first gas rise column by buoyancy provided by the transported gas,
   hydrogen gas connecting means provided at the lower end of the first waterfilled gas rise column and arranged to provide a detachable gas transport connection between the electrolysis unit and the gas inlet of the hydrogen gas transport vessel, and hydrogen gas delivering means provided at the upper end of the first waterfilled gas rise column and arranged to provide a detachable gas transport connection between the gas outlet and a hydrogen gas collector;
an oxygen subsystem comprising:
   at least one oxygen gas transport vessel provided with at least one cavity, a gas inlet and a gas outlet leading to the cavity, and arranged to receive a predetermined volume of oxygen gas in the cavity and to transport the oxygen gas from the bottom to the top of the second gas rise column by buoyancy provided by the transported gas,
   oxygen gas connecting means provided at the lower end of the second waterfilled gas rise column and arranged to provide a detachable gas transport connection between the electrolysis unit and the gas inlet of the oxygen gas transport vessel, and oxygen gas delivering means provided at the upper end of the second waterfilled gas rise column and arranged to provide a detachable gas transport connection between the gas outlet and an oxygen gas collector; and
a heat transfer unit connected to the electrolysis unit and to the hydrogen gas connecting means or the hydrogen gas transport vessel, the heat transfer unit being arranged to transfer at least a portion of the waste heat from the electrolysis unit to hydrogen gas in the hydrogen gas delivering means or to hydrogen gas in the hydrogen gas transport vessel,
   the heat transfer unit further being connected to the oxygen gas connecting means or the oxygen gas transport vessel, the heat transfer unit being arranged to transfer at least a portion of the waste heat from the electrolysis unit to the oxygen gas in the oxygen gas delivering means or to oxygen gas in the oxygen gas transport vessel.

The combined system according to the second aspect may be configured according to any one of the above listed embodiments of the system according to the first aspect.

The systems according to the first and second aspects may comprise one or more structural elements for forming the waterfilled gas rise column(s), i.e., by filling the structural element(s) with water. Alternatively, the systems may be submerged into a water volume forming the waterfilled gas rise column(s), such as a lake, the sea, or similar.

The systems according to the first and second aspects may in some embodiments comprise the one or more waterfilled gas rise columns.

According to a third aspect of the invention a method of operating the above-described systems is provided. The electrolysis unit produces at least hydrogen gas during which production waste heat is produced and the method comprises the steps of
a) the gas transport vessel arriving to and being maintained at the lower end of the gas rise column;
b) transferring a predetermined volume of gas from the electrolysis unit to the gas transport vessel;
c) heating the gas during the transfer or after the gas has been received by the gas transport vessel;
d) releasing the gas transport vessel which moves upwards in the gas rising column due to buoyancy;
e) the gas transport vessel moving upwards by buoyancy, wherein the upward motion is controlled by monitoring the internal gas pressure in the gas transport vessel and the external pressure outside of the gas transport vessel and selecting settings of the control valve to provide a predetermined buoyancy;
f) delivering the gas from the transport vessel to the gas collector at the top of the gas rise column;
g) transporting the gas transport vessel back to the lower end of the gas rise column.

The method may be used for operating the system according to the first aspect, or according to the second aspect. When the method is used to operate the system according to the second aspect, the method steps for handling hydrogen gas are carried out in the hydrogen subsystem and the method steps for handling oxygen are carried out in the oxygen subsystem.

According to one embodiment of the invention the method, in the step of transporting the gas transport vessel back to the lower end of the gas rise column, the gas transport vessel is waterfilled and thereby made to sink.

According to one embodiment of the invention the method, in the step of the gas transport vessel moving upwards to the top of the gas rise column, the buoyancy of the gas transport vessel is utilized in driving the electrical generator.

According to one embodiment of the invention, the gas transport vessel comprises an incompressible container provided with an main cavity, an expansion vessel is arranged to be able to change volume and be affected by both internal and external pressure, and a tubing connecting the incompressible container and the expansion vessel is provided, the tubing being provided with a control valve, wherein the method in the step of the gas transport vessel moving upwards by buoyancy comprises controlling the upward motion by monitoring the internal gas pressure in the gas transport vessel and the external pressure outside of the gas transport vessel and selecting settings at least of the pressure regulating valve to provide a predetermined buoyancy;
a tubing connecting the incompressible container and the expansion vessel, the tubing provided with a control valve.

According to one embodiment of the invention the incompressible container is double walled providing an insulating space between an inner wall and an outer wall of the incompressible container, and wherein in the step of the gas transport vessel moving upwards, pressure regulating means are active, equalizing the pressure in the main cavity and the insulating space.

Thanks to the invention the total efficiency of a system for producing hydrogen gas may be greatly increased. This has a great impact in bringing down the cost of production for “green” production of hydrogen or the combination of hydrogen and oxygen.

One advantage of the invention, if partly submerged into the sea, a lake, or the like, forming the waterfilled gas rise column(s), is that both the pressure available at the depth and the buoyancy from the produced gas is utilized to enhance the performance of the system.

One further advantage is that the system is scalable.

A further advantage is that newly developed electrolyze units capable of operating with natural water, such as seawater, may be utilized in a very efficient way.

In the following, the invention will be described in more detail, by way of example only, with regard to non-limiting embodiments thereof, reference being made to the accompanying drawings.

### BRIEF DESCRIPTION OF THE DRAWINGS

FIG. 1 is a schematic illustration of the hydrogen gas production system according to one embodiment of the invention;

FIGS. 2a-c are a schematic illustrations of the gas transport vessel of the hydrogen gas production system according to embodiments of the invention;

FIG. 3 is a schematic illustration of the gas transport vessel of the hydrogen gas production system according to one embodiment of the invention;

FIG. 4 is a schematic illustration of a combined hydrogen and oxygen gas production system according to one embodiment of the invention; and

FIG. 5 is a schematic illustration of a gas vessel transportation arrangement for the hydrogen gas production system according to one embodiment of the invention.

### DETAILED DESCRIPTION

Terms such as “top”, “bottom”, upper”, lower”, “below”, “above” etc. are used merely with reference to the geometry of the embodiment of the invention shown in the drawings and/or during normal operation of the described device and system and are not intended to limit the invention in any manner.

The system for producing gas according to the invention will be described as either being immersed in water or at least partly being operated in upstanding columns filled with water. For a number of reasons, not at least cost and that water is the starting material for an electrolysis process producing hydrogen and oxygen gas, water is the typical and preferred choice of a liquid for parts of the system to operate in. However, the invention is not limited to water and also other liquids may be utilized.

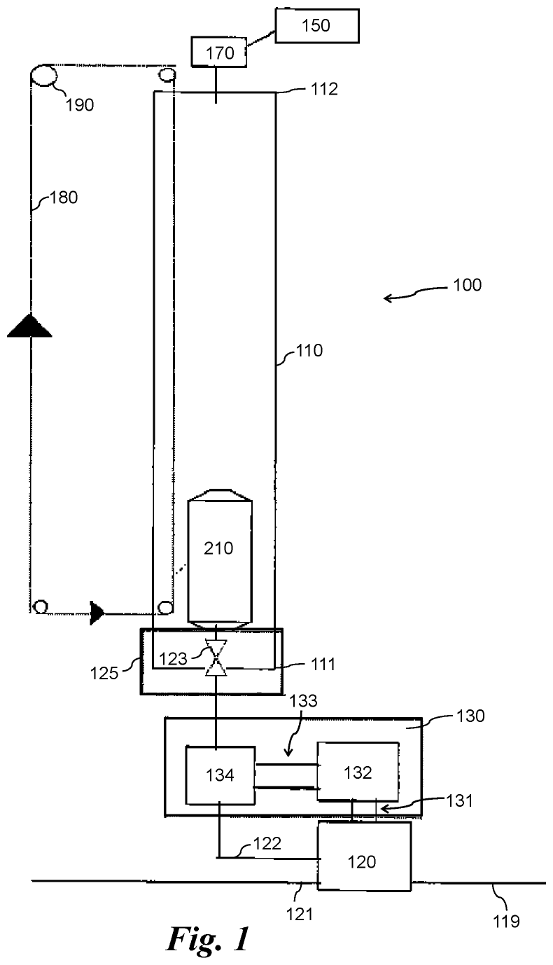

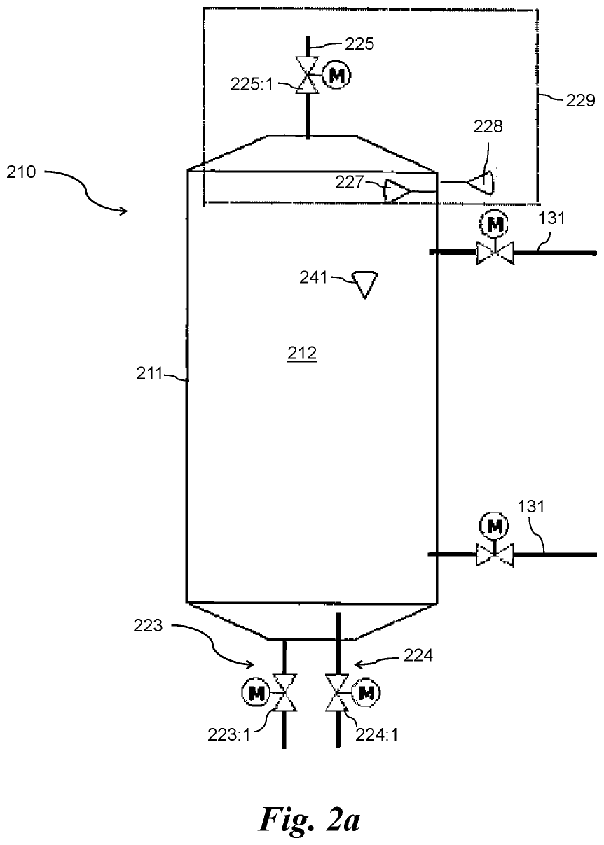

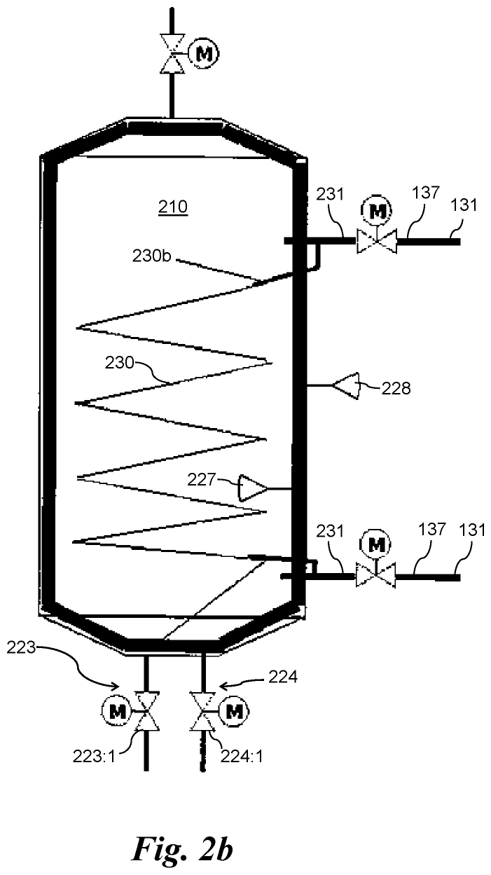

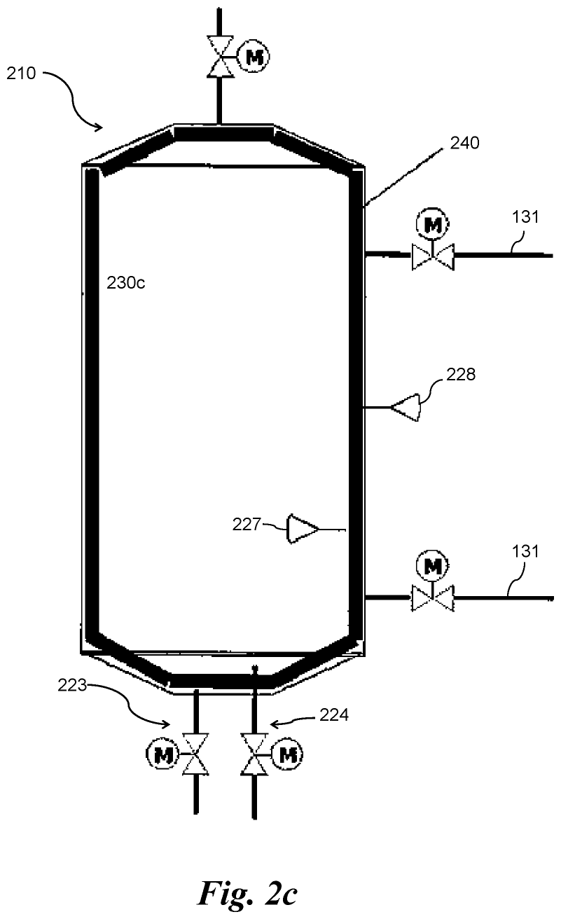

According to one aspect of the invention a system 100 for producing gas is provided. The system 100 for producing gas according to the invention is schematically illustrated in FIG. 1 and comprises the main structural elements of a waterfilled gas rise column 110; an electrically driven electrolysis unit 120, a heat transfer unit 130 and at least one a gas transport vessel 210, illustrated in greater detail in FIGS. 2a-c. An electric connector 119, such as an electric power cable, is arranged for supplying electric power to the electrolysis unit 120. The waterfilled gas rise column 110 may according to embodiments of the invention be an actual structural element, for example an upstanding elongated cylinder of steel or reinforced concrete, for example as depicted in FIG. 1. Alternatively, the system for producing gas 100 is submerged underwater and the waterfilled gas rise column 110 should be seen as a part of the water volume wherein the gas transport vessel 210 is travelling up and down, not necessarily enclosed in another structural element. The electrolysis unit 120 is arranged to during use split water into hydrogen gas and oxygen gas in an electrolysis process and is provided with at least one water inlet 121 and at least one gas outlet 122, wherein the at least one gas outlet 122 is provided at a lower end 111 of the waterfilled gas rise column 110 and is arranged to lead the produced gas or gases into the interior of the gas rise column 110. The waterfilled gas rise column 110 is extended in the vertical direction and is provided with a gas collector 170 at an upper end 112 thereof. The gas collector 170 is typically connected to a compressor 150 or other means for providing the gas in pressurized form. The gas produced by the electrolysis unit 120 is lead to the gas outlet 122 in the gas rise column 110 and the gas outlet 122 has the function of a gas docking device 123 adapted to connect to a gas inlet 223 of a gas transport vessel 210, schematically illustrated in FIG. 2a. The gas outlet 122, the gas docking device 123 and the gas inlet 223 of the gas transport vessel 210 forms gas connecting means 125 that provides the functionality of delivering gas to the gas transport vessel 210, or a series of regularly arriving gas transport vessels 210, typically in regular intervals. The gas transport vessel 210 is arranged to receive a predetermined volume of gas at the lower end 111 of the gas rise column 110 and by buoyancy rise through the gas rise column 110 and deliver the gas to the gas collector 170 on the upper end 112 of the gas rise column 110.

According to embodiments of the invention, the system for producing gas 100 comprises a plurality of gas transport vessels 210 linked to together in an endless belt or a belt-type or chain-like arrangement 180 stretching the length of the gas rise column 110 and arranged so that the gas transport vessels 210 travel upwards and downwards between the lower end 111 and the upper end 112. According to one embodiment the gas transport vessels 210 is arranged to travel upwards within the gas rise column 110 and downwards outside of the gas rise column 110. According to one embodiment the endless belt arrangement 180 comprises an electric generator 190 driven by the belt and which is powered by the buoyancy of the gas transport vessels 210 rising in the gas rise column 110. Alternatively, the rotation or other movement that is produced by the belt arrangement 180 may be used to directly drive for example a compressor or other type of machinery.

The gas docking device 123 comprises a valve that can regulate the flow and pressure of the gas and completely close the gas outlet 122 when the gas transport vessel 210 has received the predetermined volume of gas and thereby move upwards from the lower end 111 of the gas rise column 110. The gas docking device 123 may be communicatively connected to, and controlled by, a central control unit.

The heat transfer unit 130 of the system for producing gas 100 is provided to transfer excess heat produced by the electrolysis unit 120 to the gas produced by the electrolysis unit 120 before the gas is introduced into the gas transport vessel 210 or alternatively the heat transfer unit 130 is arranged to transfer heat to the produced gas within the gas transport vessel 210. By heating the gas that is to be introduced to or is already introduced into the gas transport vessel 210, the buoyancy of the gas transport vessel 210 may be increased as compared with the buoyancy afforded by the non-heated gas.

According to one embodiment of the invention the heat transfer unit 130 comprises a first heat circuitry 131 that serves as the cooling member of the electrolysis unit 120 and thereby functions as a heat collecting part and typically is in direct contact with the heat producing parts of the electrolysis unit 120. The first heat circuitry 131 comprises a first heat carrying medium. A heat exchanger 132 transfers the produced heat to a second heat circuitry 133 with a second heat carrying medium. The heat exchanger 132 and the first and second heat circuitry 131, 133 operate according to well-known principles in the area of heat exchangers and may for example comprise a plurality of pumps that circulate the first and second heat carrying medium in respective first 131 and second heat circuitry 133. The second heat circuitry 133 is either directly or indirectly arranged to heat the gas produced by the gas transport vessel 210 and the heating of the gas may be provided either upstream or downstream of the gas outlet 122, wherein downstream implies that the heating take place within the gas transport vessel 210.

According to one embodiment the second heat circuitry 133 comprises a gas heater 134 provided downstream the electrolysis unit 120 and upstream of, but in close proximity of, the gas outlet 122. The gas heater 134 may be a flow through gas heater of conventional design. The second heat circuitry 133 may also comprise one or more accumulators to store the produced heat.

The gas transport vessel 210 according to embodiments of the invention is schematically illustrated in FIGS. 2a-c and comprises a main body 211 with an internal cavity 212. The gas inlet 223 is provided at the lower end of the gas transport vessel 210 and leads into the cavity 212. A gas outlet 225 is provided at the upper end of the gas transport vessel 210 and leads out from the cavity 212. The gas inlet 223 and the gas outlet 225 are provided with control valves, inlet valve 223:1 and outlet valve 225:1 and is arranged to during use receive gas and deliver gas, respectively. The outlet valve 225:1 is a control valve further arranged to function as a pressure regulating valve and during use arranged to provide fluid communication between the cavity 212 and the exterior of the gas transport vessel 210 or to a gas container separate from the cavity 212. An evacuation outlet 224 provided with an evacuation valve 224:1 extends from the cavity 212 to the exterior of the gas transport vessel 210 and is arranged to, during filling the cavity 212 with gas, be open to let the water that is typically in the main cavity prior to filling out. The gas transport vessel 210 is further provided with an internal pressure sensor 227 arranged to provide a measure of the pressure of the gas contained in the cavity 212 and an external pressure sensor 228 arranged to provide a measure of the pressure of the water surrounding the gas transport vessel 210. The internal pressure sensor 227 and the external pressure sensor 228 are arranged to affect the regulation of the outlet control valve 225:1 and forms a pressure regulating arrangement 229. Optionally also, or alternatively, the evacuation valve 224:1 can be used to regulate the pressure in the cavity 212 and be arranged to be affected by the internal pressure sensor 227 and the external pressure sensor 228. The internal pressure sensor 227, the external pressure sensor 228, the evacuation valve 224:1 and the outlet control valve 225:1 may be arranged to interact mechanically, hydrodynamically or electronically. Preferably, the internal pressure sensor 227 and the external pressure sensor 228 are electronic devices providing digitized outputs that may be received by a control unit (not shown) and used to calculate and transmit a desired setting to the outlet control valve 225:1 and/or the evacuation valve 224:1, which in that case are an electronically or electrical controlled valves. The internal pressure sensor 227, the external pressure sensor 228, the outlet control valve 225:1 and optionally the evacuation valve 224:1 are utilized to control the pressure inside the cavity 212 in relation to the pressure outside of the gas transport vessel 210 so that a desired and predetermined buoyancy is achieved. The setting of the outlet control valve 225:1 and/or the evacuation valve 224:1 will depend on the depth (giving the pressure) of which the gas transport vessel 210 is positioned at a given instant during the gas transport vessel's upward motion. Further, by continuously or semi-continuously controlling the outlet control valve 225:1 and/or the evacuation valve 224:1 during the upward motion, the motion can be controlled and may be optimized for different scenarios. For example, but not limited to optimizing for a maximal gas deliverance to the gas collector 170 and a slow upward motion or to provide a maximum force from buoyancy utilized to give a fast upward motion or to utilize the upward force in other ways. The gas transport vessel 210 may be provided with further pressure sensors and/or temperature sensors 241 to further control and regulate the upward motion of the gas transport vessel 210. Measuring temperature inside the gas transport vessel 210 could provide the same information as measuring the pressure. As appreciated by the skilled person the details of the pressure regulating arrangement 229 may be varied and still provide the above functionality.

According to one embodiment, the control unit may have one or more pressure profiles stored, the pressure profiles giving the optimal pressure settings at the varying external pressure, or water depth, for different desired scenarios, for example the optimizations for maximum gas delivery or maximum force described above.

According to one embodiment, the second heat circuitry 133 provides the heating of the gas within the gas transport vessel 210, which is schematically illustrated in FIG. 2b. According to this embodiment the gas transport vessel 210 is provided with an internal heating arrangement 230. During parts of the operation, the second heat circuitry 133 is connected to the internal heating arrangement 230 of the gas transport vessel 210 so that these parts of the gas transport vessel 210 functionally form part of the second heat circuitry 133.

According to some embodiments the gas transport vessel 210 comprises the internal heating arrangement 230 and means for connecting the internal heating arrangement 230 to the heat transfer unit 130, so that functionally the internal heating arrangement 230 forms a part of the second heat circuitry 133 and so that second heat carrying medium flows from the heat exchanger 132 to the heating arrangement 230. Thereby, the heating arrangement 230 during operation is the heat delivering part of the heat transfer unit 130. Waste heat produced in the electrolysis unit 120 is thereby be transferred via the heat transfer unit 130 to the gas transport vessel 210. The means for connecting the heating arrangement 230 of the gas transport vessel 210 to the heat transfer unit 130 may be in the form of a pair of docking devices 231 connecting to corresponding docking devices 137 provided in the gas rise column 110, the corresponding docking devices being provided with regulating valves and in fluid communication with the heat transfer unit 130. During operation and with the gas transport vessels 210 connected to the docking device 231, heat is transferred to the gas and or/water that is contained within the gas transport vessels 210.

According to one embodiment, schematically illustrated in FIG. 2b, the heating arrangement 230 comprises a coil 230b arranged in the interior of the gas transport vessels 210.

According to an alternative embodiment, schematically illustrated in FIG. 2c, the heating arrangement 230 comprises a heating jacket 230c arranged in at least part of a wall 240 of the gas transport vessel 210.

The functions of the members of the system for producing gas according to the invention will be illustrated by describing the principle of operation which also is a method of operating the system:
a) A gas transport vessel 210 arrives at the lower end of the gas rise column 110 and the docking device 123 connects to the gas inlet 223 of the gas transport vessel 210.

According to embodiments of the invention the heating arrangement 230 of the gas transport vessel 210 connects to the pair of docking devices 137 of the heat transfer unit 130. Alternatively, the gas heater 134 is activated.
b) Gas produced in the electrolysis unit 120 with a pressure and temperature that is given by the electrolysis unit 120 is transferred to the gas transport vessel 210.
c) Heat is transferred from heat transfer unit 130 to the gas contained in the gas transport vessel 210 via the heating arrangement. Alternatively, if the gas heater 134 is utilized for heating, the gas is heated during the transfer into the gas transport vessel 210.
d) The gas transport vessel 210 is released and starts moving upwards.
e) The upward motion of the gas transport vessel 210 will be controlled by controlling the gas pressure within the cavity 212 in relation with the external pressure the gas transport vessel 210 is subjected to. The gas pressure in the cavity 212 will be provided by internal pressure sensor 227, and the external water pressure by the external pressure sensor 228. The data from the pressure sensors forming the basis for selecting settings of the evacuation valve 224:1 and/or the outlet control valve 225:1 to provide a desired and predetermined buoyancy.
f) The gas is delivered from the gas transport vessel 210 to the gas collector 170.
g) The gas transport vessel 210 is transported back to the lower end of the gas rise column 110. Preferably the valves of the gas transport vessel 210 are arranged so that the vessel is waterfilled and sinks to the lower end of the gas rise column 110.

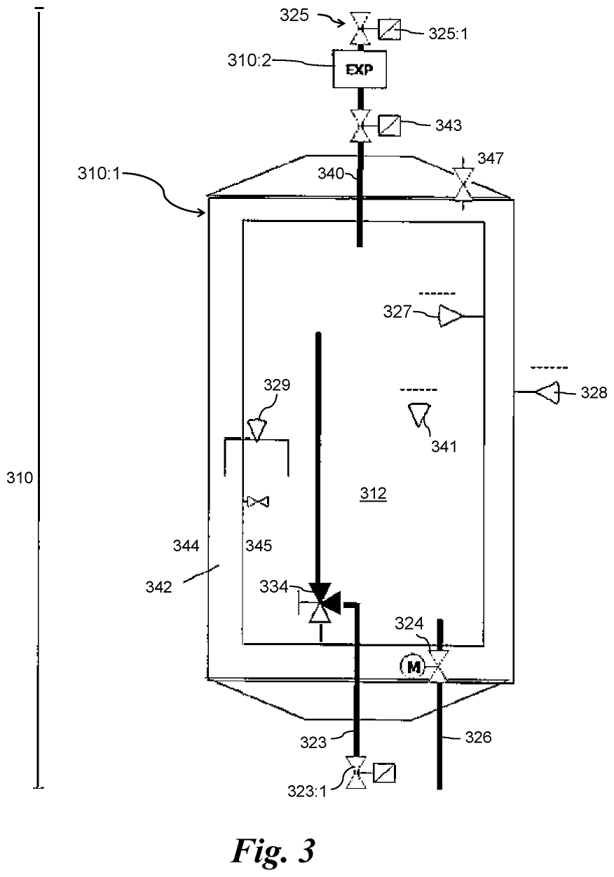

According to one embodiment of the invention, schematically illustrated in FIG. 3, the gas transport vessel 310 comprises an incompressible container 310:1 and an expansion vessel 310:2. The incompressible container 310:1 is arranged not to be compressed or deformed during use and may for example be made of steel or reinforced plastic. The expansion vessel 310:2 is arranged to be able to change volume and will be affected by both internal and external pressure. The expansion vessel 310:2 may for example be in the form of a rubber bladder or the like. The incompressible container 310:1 and the expansion vessel 310:2 are connected with a tubing 340 provided with a control valve 343. The expansion vessel 310:2 is provided with an outlet 325 with an outlet control valve 325:1, corresponding to the outlet arrangements described with references to FIG. 2 a-b. The incompressible container 310:1 is preferably double walled so that an insulating space 342 is formed between an inner 345 and outer wall 344. A drainage outlet 326 leads from an inner cavity, main cavity 312 to the exterior of the gas transport vessel 310, via a first volume and pressure regulating valve 324. The gas transport vessel 310 is provided with a gas inlet 323 which is provided with inlet control valve 323:1 and wherein the inlet 323 via a second volume and pressure regulating valve 334 is in fluid communication with either the main cavity 312 or the insulating space 342, depending on how the second volume and pressure regulating valve 334 is set. The gas transport vessel 310 is further provided with an internal pressure sensor 327 arranged to provide a measure of the pressure of the gas contained in the cavity 312 and an external pressure sensor 328 arranged to provide a measure of the pressure of the water surrounding the gas transport vessel 310. The internal pressure sensor 327 and the external pressure sensor 328 are arranged to affect the regulation of the control valve 343 and optionally also the first volume and pressure regulating valve 324, and forms the main part of a pressure regulating arrangement. The internal pressure sensor 327, the external pressure sensor 328, the first volume and pressure regulating valve 324 and the control valve 343 may be arranged to interact mechanically or hydrodynamically. Preferably, the internal pressure sensor 327 and the external pressure sensor 328 are electronic devices providing digitized outputs that may be received by a control unit (not shown) and used to calculate and transmit a desired setting to the control valve 343 and the pressure regulating valve 224, which in that case are an electronically or electrical controlled valves. The internal pressure sensor 327, the external pressure sensor 328, the first volume and pressure regulating valve 324 and the control valve 343 are utilized to control the pressure inside the main cavity 312 in relation to the pressure outside of the gas transport vessel 310. The incompressible container 310:1 may further be provided with a differential pressure sensor 329 arranged to provide a measure of the difference in the gas pressure in the main cavity 312 and the insulating space 342. The differential pressure sensor 329 is arranged to affect the second volume and pressure regulating valve 334 to regulate and equalize the pressure between the main cavity 312 and the insulating space 342. The differential pressure sensor 329 may alternatively be realized with separate pressure sensors in the insulating space 342 and the main cavity 312, or using the internal pressure sensor 327 also for this purpose. Similar to above, the differential pressure sensor 329 may communicate with the second volume and pressure regulating valve 334 mechanically. Preferably the differential pressure sensor 329 is an electronic sensor and the communication with the second volume and pressure regulating valve 334 is digital. A venting valve 347 may be provided in the top part of the insulating space 342 and leading to the exterior of the transport vessel 310. The venting valve 347 is arranged to evacuate gas or air from the insulating space 342. The gas transport vessel 310 may also comprise other sensors such as one or more temperature sensors 341 or further pressure sensors.

According to one embodiment the gas transport vessel 310 comprises a central control unit and a power supply and all pressure sensors and controllable valves are in connection and controlled by the central control unit.

The embodiments and alternatives described with reference to FIGS. 2a-b are relevant also for the gas transport vessel 310 comprising an incompressible container 310:1 and an expansion vessel 310:2, where technically feasible. In particular, the gas transport vessel 310 comprises an incompressible container 310:1 and an expansion vessel 310:2 may be provided with the internal heating arrangement described above.

The functions of the members of the gas transport vessel 310 comprising an incompressible container 310:1 and an expansion vessel 310:2 will be illustrated by describing the principle of operation, which represents one embodiment of the method of operating the system:
a) The gas transport vessel 310 arrives at the lower end of the gas rise column 110 and the docking device 123 connects to the gas inlet 323 of the gas transport vessel 310. During the preceding downward transportation, the main cavity 312 and the insulating space 342 of the gas transport vessel 310 are at least partly filled with water.
b) Gas produced in the electrolysis unit 120 is introduced via the gas inlet 323. In a first filling step, the second volume and pressure regulating valve 334 is set to direct the incoming gas to the insulating space 342. The filling of the insulating space 342 is terminated at reaching a gas pressure in the insulating space 342 that is equal to or above the surrounding water pressure at which point the insulating space 342 has been evacuated from water. In a second filling step the second volume and pressure regulating valve 334 is set to direct the incoming gas to the main cavity 312. The first volume and pressure regulating valve 324 is open to the surrounding water so that the water in the main cavity 312 may be evacuated forced by the increasing gas pressure. The filling of the main cavity 312 is terminated at reaching a gas pressure that is equal to or above the surrounding water pressure.
c) Heat is transferred from heat transfer unit 130 to the gas contained in the gas transport vessel 310 via the internal heating arrangement, preferably arranged so that only the gas in the main cavity 312 is directly heated. Alternatively, if the gas heater 134 is utilized for heating, the gas is heated during the transfer into the gas transport vessel 310.
d) The gas transport vessel 310 is released and starts moving upwards.
e) The upward motion of the gas transport vessel 310 will be controlled by controlling the gas pressure within the main cavity 312 in relation with the external pressure the gas transport vessel 310 is subjected to. The first volume and pressure regulating valve 324 will normally be closed during the upward motion. The gas pressure in the main cavity 312 will be provided by the internal pressure sensor 327 and the external water pressure by the external pressure sensor 328. The data from the pressure sensors form the basis for controlling the control valve 343 and the release of gas to the expansion vessel 310:2 and thereby the buoyancy. The differential pressure sensor 329 may detect a pressure difference between the main cavity 312 and insulating space 342 upon release of gas by the control valve 343 and the second volume and pressure regulating valve 334 is used to stabilize the pressure between the main cavity 312 and the insulating space 342.

In a first use case, the valves are controlled to maintain as high gas pressure as possible in the main cavity 312 during the upward motion phase. Hence, the control valve 343 is controlled to only release gas to the expansion vessel 310:2 to provide a buoyancy that is just sufficient to maintain a positive buoyancy. Alternatively, a minimum buoyancy value may be defined and the control valve 343 is controlled to give a buoyancy above the minimum buoyancy value.

In a second use case, the valves are controlled to maximize the buoyancy. A high buoyancy may be utilized to increase the speed of the upward motion and/or to provide an upward force to the belt or the like attached to the gas transport vessel 310 for providing power generation from the belt arrangement. Hence, the control valve 343 is controlled to release gas to the expansion vessel 310:2 to provide a large positive buoyancy. Typically, the rise of the gas transport vessel 310 should not be uncontrollably fast, or the gas pressure in the main cavity 312 is “wasted”. Therefore, a maximum buoyancy value may be defined and the control valve 343 is controlled to give a buoyancy below the maximum buoyancy value. Alternatively, a buoyancy value set point or a preferred buoyancy value range is predetermined and the control valve 343 is controlled to give a buoyancy within the predetermined range. The buoyancy may be determined from measurements provided by the internal pressure sensor 327 and the external pressure sensor 328. The gas transport vessel 310 may further be provided with means for measuring the speed of the upward motion.
f) At the top of the gas rise column 110 the outlet valve 325:1 is brought in connection with the gas collector 170, the control valve 343 is opened and gas is delivered from the main cavity 312 of the gas transport vessel 310. The second volume and pressure regulating valve 334 and/or the first volume and pressure regulating valve 324 are controlled to open a connection between the main cavity 312 and the insulating space 342 so that also the gas contained in the insulating space 342 may be delivered to the gas collector 170.
g) The gas transport vessel 310 is transported back to the lower end of the gas rise column 110, preferably by that the gas transport vessel 310 is given a negative buoyancy and sinks. The negative buoyancy may be achieved after the gas transport vessel 310 being released from the gas collector 170 by the first volume and pressure regulating valve 324 opening to the surrounding water and the outlet valve 325:1 and the control valve 343 remaining open, thereby the main cavity 312 will be waterfilled. In order for the insulating space 342 to also be waterfilled, the second volume and pressure regulating valve 334 may be set to open between the main cavity 312 and the insulating space 342 and the evacuation valve 347 is opened to let the gas out.

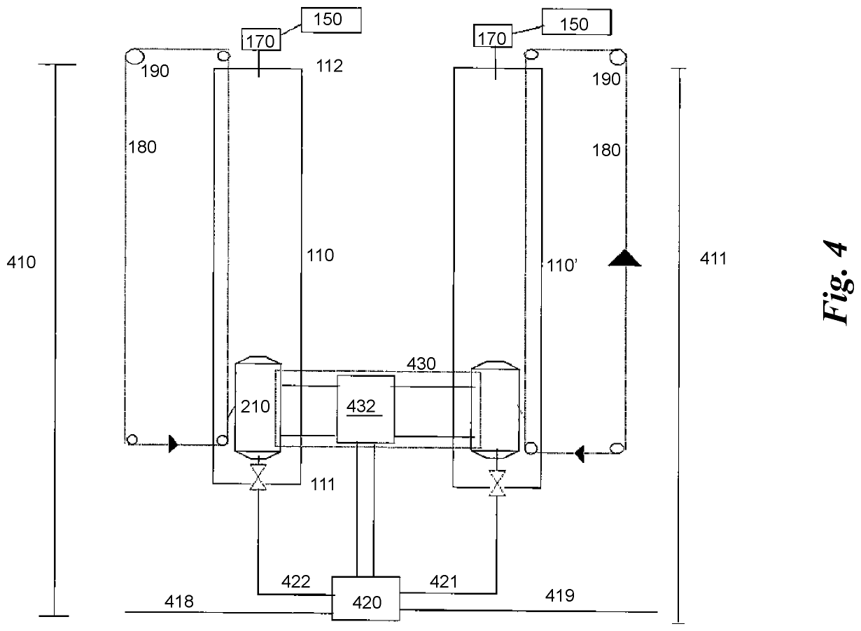

According to one aspect of the invention, a combined system 400 for producing hydrogen gas and oxygen gas is provided and is schematically illustrated in FIG. 4. In the combined system 400, the electrically driven electrolysis unit 420 is provided with a water inlet 418, an electric connector 419, a hydrogen gas outlet 422 and an oxygen gas outlet 421. The hydrogen gas outlet 422 and an oxygen gas outlet 421 leads to two separate subsystems, a hydrogen subsystem 410 and an oxygen subsystem 411 arranged in separate gas rise columns in the form of a first gas rise column 110 and a second gas column 110′, comprising separate gas transport vessels, etc. Both subsystems are constructed according to the above description and the described embodiments and alternatives are relevant for both subsystems. Preferably, the heat transfer system 430 of the combined system 400 is arranged to heat both the hydrogen and the oxygen gas with the heating arrangements following the above description. Given the difference in density, the settings of the pressure regulating means to provide the desired buoyancy will be different for the hydrogen and oxygen subsystems, such differences being obvious for the skilled person in light of the above teachings.

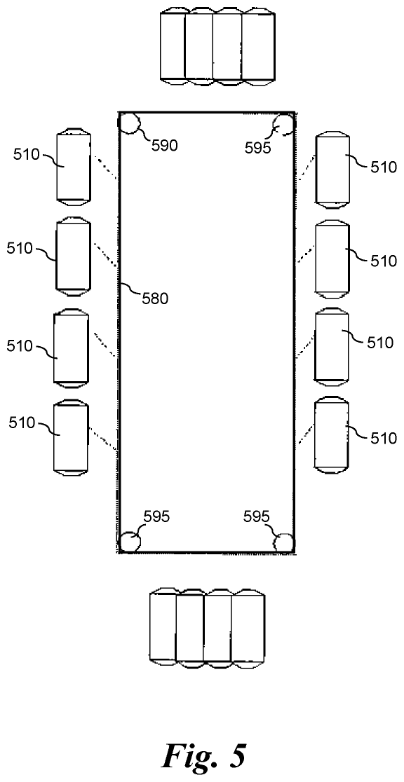

According to one implementation of the present invention, the electrolysis unit 120 and the heat transfer unit 130 are submerged into the sea, a lake or reservoir at a depth in the range of 100-500 m, preferably 200-300 m. Preferably the electrolysis unit 120 is capable of handling the water from the sea or lake directly, or with some uncomplicated filtering, such as the technique described in Solar-driven, highly sustained splitting of seawater into hydrogen and oxygenfuels, Yun Kuang et al, PNAS Apr. 2, 2019 116 (14) 6624-6629; first published Mar. 18, 2019. A system operating at a 200 m depth would have a working pressure of 20 bar. The gas transport vessels are preferably designed with a cavity in the size range of 5 m³-20 m³. If the gas transport vessels are provided with expansion vessels, these should preferably be about the same size as the main cavity, in their expanded state. In FIG. 5, part of a system for producing hydrogen gas utilizing 16 gas transport vessels 510 in connection to, and driving the belt 580, is schematically illustrated. The belt is driving at least one electrical generator 590 and may further comprise a plurality of support wheels 595 and other arrangements to temporarily disconnect and store a plurality of gas transport vessels at the top and bottom in order to facilitate the gas loading and delivery. Preferably the operation is balanced so that the same number of gas transport vessels are travelling upwards and downwards during operation. Utilizing 16 gas transport vessels of the size 12 m³ the system may be designed to produce approximately 15 000 kg H₂/day and if each gas transport vessel receives an addition of 5 kWh from the heat transfer for each load of gas transported to the top, following the example of a working depth of 200 m, the increase in buoyancy utilized by the generators driven by the belt and fed to the electrolyzing unit as a portion of the required driving current, the efficiency of the system would increase in the order of 10% or more as compared to a gas producing system not utilizing the waste heat. Conventional construction techniques and materials could be utilized in the construction of such a system, not at least the techniques developed for offshore oil drilling and the like. The material for the main container of gas transport vessels could be stainless steel or reinforced plastic, for example carbon fibre reinforced plastic. Suitable materials are commercially available.

The embodiments described above are to be understood as illustrative examples of the system and method of the present invention. It will be understood that those skilled in the art that various modifications, combinations and changes may be made to the embodiments. In particular, different part solutions in the different embodiments can be combined in other configurations, where technically possible.

1. A system for producing hydrogen gas, configured to be arranged in or in connection with a water volume forming a waterfilled gas rise column provided with a lower end and an upper end, the system comprising:
an electrically driven electrolysis unit configured to be provided in proximity to the lower end of the waterfilled gas rise column and provided with a water inlet and at least one gas outlet, the electrolysis unit being arranged to during use split water into hydrogen gas and oxygen gas in an electrolysis process in which process waste heat is produced,
at least one gas transport vessel provided with at least one cavity, a gas inlet and a gas outlet leading to the cavity, and arranged to receive a predetermined volume of hydrogen gas in the cavity and to transport the hydrogen gas from the bottom to the top of the gas rise column by buoyancy provided by the transported gas,
gas connecting means provided at the lower end of the waterfilled gas rise column and arranged to provide a detachable gas transport connection between the electrolysis unit and the gas inlet of the gas transport vessel, and gas delivering means provided at the upper end of the waterfilled gas rise column and arranged to provide a detachable gas transport connection between the gas outlet and a gas collector; and
a heat transfer unit connected to the electrolysis unit and to the gas connecting means or the gas transport vessel and arranged to transfer at least a portion of the waste heat from the electrolysis unit to hydrogen gas in the gas delivering means or to hydrogen gas in the gas transport vessel.

2. The system for producing hydrogen gas according to claim 1, wherein the heat transfer unit comprises a first heat circuitry arranged in contact with heat generating parts of the electrolysis unit and thereby cools the electrolysis unit, a second heat circuitry arranged to heat the gas produced by the electrolysis unit, and a heat exchanger arranged to transfer heat from the first heat circuitry to the second heat circuitry.

3. The system for producing hydrogen gas according to claim 2, wherein the heat transfer unit comprises a flow through gas heater provided between the electrolysis unit and the gas connecting means.

4. The system for producing hydrogen gas according to claim 2, wherein the heat transfer unit comprises an internal heating arrangement provided in the gas transport vessel and forming a part of the second heat circuitry.

5. The system for producing hydrogen gas according to claim 4, wherein the internal heating arrangement comprises a coil arranged in the interior of the gas transport vessels.

6. The system for producing hydrogen gas according to claim 4, wherein the internal heating arrangement comprises a heating jacket arranged in at least part of the wall of the gas transport vessel.

7. The system for producing hydrogen gas according to claim 1, wherein the gas transport vessel comprises a pressure regulating arrangement arranged to control the gas pressure within the cavity of the gas transport vessel in relation to the external pressure and thereby controlling the buoyancy of the gas transport vessel during the gas transport vessel filled with heated gas received from the electrolysis unit rising upward in the gas rise column.

8. The system for producing hydrogen gas according to claim 7, wherein the pressure regulating arrangement comprises:
a control valve arranged to provide fluid communication between the cavity and the exterior of the gas transport vessel or to a gas container separate from the cavity;
an internal pressure sensor arranged to provide a measure of the pressure of the gas contained in the cavity; and
an external pressure sensor arranged to provide a measure of the pressure of the water surrounding the gas transport vessel, wherein the internal pressure sensor and the external pressure sensor are arranged to affect the regulation of the control valve to control the pressure inside the cavity in relation to the pressure outside of the gas transport vessel so that a predetermined buoyancy is achieved.

9. The system for producing hydrogen gas according to claim 7, wherein the pressure regulating arrangement further comprises a control unit arranged to receive measurement data from the internal pressure sensor and the external pressure sensor and arranged to control the control valve and wherein the control unit has a stored pressure profile and arranged to regulated the control valve according to the stored pressure profile.

10. The system for producing hydrogen gas according to claim 7, wherein the gas transport vessel comprises:
an incompressible container provided with an main cavity;
an expansion vessel arranged to be able change volume and affected by both internal and external pressure, and
a tubing connecting the incompressible container and the expansion vessel, the tubing provided with a control valve;
an internal pressure sensor arranged to provide a measure of the pressure of the gas contained in the main cavity and an external pressure sensor arranged to provide a measure of the pressure of the water surrounding the gas transport vessel, and
wherein the internal pressure sensor and the external pressure sensor are arranged to affect the regulation of the control valve and thereby control the flow of gas between the main cavity and the expansion vessel.

11. The system for producing hydrogen gas according to claim 10, wherein
the incompressible container is double walled providing an insulating space between an inner and an outer wall of the incompressible container; and
the incompressible container is provided with a differential pressure sensor arranged to provide a measure of the difference in the gas pressure in the main cavity and the insulating space and a second volume and pressure regulating valve arranged to equalize the pressure between the main cavity and the insulating space.

12. The system for producing hydrogen gas according to claim 1, further comprising a belt to which a plurality of gas transport vessels are attached, the belt being arranged to drive an electrical generator.

13. A combined system for producing hydrogen gas and oxygen gas, the combined system being configured to be arranged in or in connection with at least one water volume forming a first waterfilled gas rise column provided with a lower end and an upper end, and a second waterfilled gas rise column provided with a lower end and an upper end, the combined system comprising:
an electrically driven electrolysis unit configured to be provided in proximity to the lower ends of the first and second waterfilled gas rise columns and provided with a water inlet, a hydrogen gas outlet and an oxygen gas outlet, the electrolysis unit being arranged to during use split water into hydrogen gas and oxygen gas in an electrolysis process in which process waste heat is produced,
a hydrogen subsystem-comprising:
at least one hydrogen gas transport vessel provided with at least one cavity, a gas inlet and a gas outlet leading to the cavity, and arranged to receive a predetermined volume of hydrogen gas in the cavity and to transport the hydrogen gas from the bottom to the top of the first gas rise column by buoyancy provided by the transported gas,
hydrogen gas connecting means provided at the lower end of the first waterfilled gas rise column and arranged to provide a detachable gas transport connection between the electrolysis unit and the gas inlet of the hydrogen gas transport vessel, and hydrogen gas delivering means provided at the upper end of the first waterfilled gas rise column and arranged to provide a detachable gas transport connection between the gas outlet and a hydrogen gas collector;
an oxygen subsystem comprising:
at least one oxygen gas transport vessel provided with at least one cavity, a gas inlet and a gas outlet leading to the cavity, and arranged to receive a predetermined volume of oxygen gas in the cavity and to transport the oxygen gas from the bottom to the top of the second gas rise column by buoyancy provided by the transported gas,
oxygen gas connecting means provided at the lower end of the second waterfilled gas rise column and arranged to provide a detachable gas transport connection between the electrolysis unit and the gas inlet of the oxygen gas transport vessel, and oxygen gas delivering means provided at the upper end of the second waterfilled gas rise column and arranged to provide a detachable gas transport connection between the gas outlet and an oxygen gas collector; and
a heat transfer unit connected to the electrolysis unit and to the hydrogen gas connecting means or the hydrogen gas transport vessel, the heat transfer unit being arranged to transfer at least a portion of the waste heat from the electrolysis unit to hydrogen gas in the hydrogen gas delivering means or to hydrogen gas in the hydrogen gas transport vessel,
the heat transfer unit further being connected to the oxygen gas connecting means or the oxygen gas transport vessel, the heat transfer unit being arranged to transfer at least a portion of the waste heat from the electrolysis unit to the oxygen gas in the oxygen gas delivering means or to oxygen gas in the oxygen gas transport vessel.

14. A method of operating the system according to claim 1, wherein the electrolysis unit produces at least hydrogen gas during which production waste heat is produced, the method comprising the steps of:
a) the gas transport vessel arriving to and being maintained at the lower end of the gas rise column;
b) transferring a predetermined volume of hydrogen gas from the electrolysis unit to the gas transport vessel;
c) heating the hydrogen gas during the transfer or after the hydrogen gas has been received by gas transport vessel;
d) releasing the gas transport vessel which moves upwards in the gas rising column due to buoyancy;
e) the gas transport vessel moving upwards by buoyancy, wherein the upward motion is controlled by monitoring the internal gas pressure in the gas transport vessel and the external pressure outside of the gas transport vessel and selecting settings of the control valve to provide a predetermined buoyancy;
f) delivering the hydrogen gas from the transport vessel to the gas collector at the top of the gas rise column;
g) transporting the gas transport vessel back to the lower end of the gas rise column.

15. The method for producing hydrogen gas according to claim 14, wherein in the step of transporting the gas transport vessel back to the lower end of the gas rise column, the gas transport vessel is waterfilled and sinks.

16. The method for producing hydrogen gas according to claim 14, wherein in the step of the gas transport vessel moving upwards to the top of the gas rise column, the buoyancy of the gas transport vessel is utilized in driving an electrical generator.

17. The method for producing hydrogen gas according to claim 14, wherein the gas transport vessel comprises an incompressible container provided with an main cavity, an expansion vessel is arranged to be able to change volume and be affected by both internal and external pressure, and a tubing connecting the incompressible container and the expansion vessel is provided, the tubing being provided with a control valve, wherein the method in the step of the gas transport vessel moving upwards by buoyancy comprises controlling the upward motion by monitoring the internal gas pressure in the gas transport vessel and the external pressure outside of the gas transport vessel and selecting settings at least of the pressure regulating valve to provide a predetermined buoyancy.

18. The method for producing hydrogen gas according to claim 17, wherein the incompressible container is double walled providing an insulating space between an inner wall and an outer wall of the incompressible container, and wherein, in the step of the gas transport vessel moving upwards, pressure regulating means are active, equalizing the pressure in the main cavity and the insulating space.
